(19) United States
(12) Patent Application Publication
(10) Pub. No.: US 2009/0061348 A1
(43) Pub. Date: Mar. 5, 2009

(54) ELECTROPHOTOGRAPHIC IMAGE-RECEIVING SHEET AND IMAGE FORMING METHOD USING THE SAME

(75) Inventors: Hiroyuki Naoi, Shizuoka (JP); Atsushi Kato, Shizuoka (JP); Hirobumi Mitsuo, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/198,406

(22) Filed: Aug. 26, 2008

(30) Foreign Application Priority Data
Aug. 27, 2007 (JP) 2007-220168

(51) Int. Cl. G03G 13/20; B32B 5/16

(52) U.S. Cl. 430/124.53; 428/323

(57) ABSTRACT

The present invention provides an electrophotographic image-receiving sheet including a support having raw paper and a resin layer on at least one surface of the raw paper; and at least one coating layer on the support, wherein the thickness of the resin layer at least on the image-forming side is 5 μm to 15 μm, the coating layer contains at least hollow particles, and the amount of the hollow particles contained in the coating layer is 0.5 g/m² or more.

### BACKGROUND OF THE INVENTION

1. Field of the Invention

The present invention relates to an electrophotographic image-receiving sheet which can provide a high-glossiness, high-quality image comparable to a silver-halide photograph with a single fixation (only a primary fixation); and an image forming method using the electrophotographic image-receiving sheet.

2. Description of the Related Art

Electrophotography, which employs a dry process and exhibits an excellent printing speed, can output an image on general-purpose paper such as plain paper or woodfree paper. Therefore, conventionally, this method has been widely employed in copying machines and output devices for personal computers.

Recent interest has focused on realizing a high-quality electrophotographic image comparable to a silver-halide photograph, which is required particularly when output images (pictures) of faces, scenes, etc. are to be obtained. Under such circumstances, there has been developed and used an electrophotographic image-receiving sheet specialized for use in electrophotography. The electrophotographic image-receiving sheet includes a support having raw paper and a resin layer on at least one surface of the raw paper; and at least a toner-receiving layer on the support.

However, a satisfactorily high-glossiness, high-quality image, which is comparable to a silver-halide photograph, has not yet been obtained using such an electrophotographic image-receiving sheet, and keen demand has arisen for an improved electrophotographic image-receiving sheet. In view of the foregoing, the present applicant has previously proposed a method including a primary fixation, and a secondary fixation by a belt-fixing method (see Japanese Patent Application Laid-Open (JP-A) Nos. 2000-66466 and 2005-4038). This method can provide a high-quality image having an improved smoothness and glossiness comparable to a silver-halide photograph. Nevertheless, such a method that a fixing treatment is carried out twice requires a complicated device configuration due to the increased number of steps, and is difficult to put into practice widely. Therefore, there is a demand for a printing technique which can provide a photo-like image having high glossiness with a single fixation.

One proposed electrophotographic image-receiving material includes a reflective support and a coating layer which is formed on the reflective support and which contains hollow particles or porous particles and a hydrophilic binder (see JP-A No. 2007-133156). From this document, the material can provide with a single fixation (a primary fixation) an image having high glossiness and having no uncomfortability due to toner irregularities.

The aforementioned reflective support is preferably formed of raw paper and a resin layer (e.g., a polyethylene layer) coated on one or both surfaces of the raw paper. In EXAMPLES of this document, the support is formed as follows; the back surface of a white paper base is provided with a resin layer (20 g/m²) by melt extrusion lamination of polyethylene at 300° C., and the front surface of the white paper base is provided with a resin layer (15 g/m²) by melt extrusion lamination (at 300° C.) of a kneaded product of polyethylene (91% by mass) and rutile-type titanium oxide (9% by mass). However, as described in JP-A No. 2007-133156, the support having the resin layer whose weight is as much as 15 g/m² or more; i.e., which is too thick, exhibits a thermal conductivity much higher than required. Therefore, during fixation, heat applied is undesirably easier to be conducted to the raw paper, and thus toner particles are difficult to crush or fuse. As a result, the surface of the formed image is not smooth, problematically causing light scattering and thus not attaining satisfactory glossiness. In addition, since a hollow particle-containing layer is as thick as 40 μm, a toner fixing property is problematically deteriorated.

Therefore, there has been keenly demanded provision of an electrophotographic image-receiving sheet which can provide a high-glossiness, high-quality image comparable to a silver-halide photograph with a single fixation (only a primary fixation) and which exhibits an excellent toner fixing property; and an image forming method using the electrophotographic image-receiving sheet.

### BRIEF SUMMARY OF THE INVENTION

Accordingly, an object of the present invention is to provide an electrophotographic image-receiving sheet which can provide a high-glossiness, high-quality image comparable to a silver-halide photograph with a single fixation (only a primary fixation) and which exhibits an excellent toner fixing property; and an image forming method using the electrophotographic image-receiving sheet.

The present invention provides the following in order to solve the above-described problems.

<1> An electrophotographic image-receiving sheet including a support having raw paper and a resin layer on at least one surface of the raw paper; and at least one coating layer on the support, wherein the thickness of the resin layer at least on a side where an image is to be formed (image-forming side) is 5 μm to 15 μm, the coating layer contains at least hollow particles, and the amount of the hollow particles contained in the coating layer is 0.5 g/m² or more.

<2> The electrophotographic image-receiving sheet according to <1> above, wherein the volume average particle size of the hollow particles is 0.3 μm or more.

<3> The electrophotographic image-receiving sheet according to any one of <1> and <2> above, wherein the resin layer is formed on both surfaces of the raw paper, and the difference in thickness is −3 μm to +3 μm between the resin layer on the image-forming side and the resin layer on a side opposite to the image-forming side.

<4> The electrophotographic image-receiving sheet according to any one of <1> to <3> above, wherein the resin layer contains a mixture of low-density polyethylene (LDPE) and high-density polyethylene (HDPE), and the ratio LDPE/HDPE is 10/90 to 90/10 by mass.

<5> An image forming method including, forming a toner image on the electrophotographic image-receiving sheet according to any one of <1> to <4> above, and fixing the toner image by a heating and pressing member.

An electrophotographic image-receiving sheet of the present invention includes a support having raw paper and a resin layer on at least one surface of the raw paper; and at least one coating layer on the support, wherein the thickness of the resin layer at least on an image-forming side is 5 μm to 15 μm, the coating layer contains at least hollow particles, and the amount of the hollow particles contained in the coating layer is 0.5 g/m² or more.

In the electrophotographic image-receiving sheet of the present invention, the resin layer formed on at least one surface of the raw paper has a thickness as thin as 5 μm to 15 μm or less. Therefore, the electrophotographic image-receiving sheet exhibits low thermal conductivity. In addition, since hollow particles, which exhibit excellent thermal insulation properties, are incorporated into the coating layer in an amount of 0.5 g/m² or more, heat applied to the sheet during fixation is not easily conducted to the raw paper, resulting in that toner particles are readily crushed or fused. Therefore, the smoothness of an image formed of the crushed/fused toner is improved and thus, there can be provided a high-glossiness, high-quality image comparable to a silver-halide photograph.

An image forming method of the present invention includes a toner-image forming step and a fixing step. In the toner-image forming step, a toner image is formed on the electrophotographic image-receiving sheet of the present invention. In the fixing step, a toner image formed in the toner-image forming step is fixed by a heating and pressing member. The method of the present invention realizes formation of a high-glossiness, high-quality image comparable to a silver-halide photograph with a single fixation (only a primary fixation).

### BRIEF DESCRIPTION OF THE SEVERAL VIEWS OF THE DRAWINGS

FIG. 1 is a schematic view of an image-forming apparatus used in an image forming method of the present invention.

FIG. 2 shows a fixing device using a heating roller.

### DETAILED DESCRIPTION OF THE INVENTION

### Electrophotographic Image-Receiving Sheet

An electrophotographic image-receiving sheet of the present invention includes a support and at least one coating layer on the support and, if necessary, includes other layers in accordance with needs.

### <Support>

The support has raw paper and a resin layer on at least one surface of the raw paper. Preferably, the resin layer is formed on both surfaces of the raw paper. Notably, at least one resin layer is formed; i.e., two or more resin layers are formed.

### —Raw Paper—

The raw paper is not particularly limited and can be appropriately selected depending on the purpose. Specific examples of preferred raw paper include woodfree paper; e.g., paper described in “Basis of Photographic Technology-silver halide photograph (edited by The Society of Photographic Science and Technology of Japan and published by Corona Publishing Co., Ltd. (1979)) (pp. 223-224)”).

In order to obtain raw paper having a surface exhibiting a desired mean center line roughness, it is preferably formed as described in, for example, JP-A No. 58-68037 from pulp fibers having a fiber length distribution in which, for example, a total of a 24-mesh-screen-remnant and a 42-mesh-screen-remnant is from 20% by mass to 45% by mass, and the 24-mesh-screen-remnant is 5% by mass or less. Alternatively, the mean center line roughness of raw paper can be controlled by subjecting the raw paper to a surface treatment including application of heat and pressure using a machinecalender or a supercalender.

The material for forming the raw paper is not particularly limited and can be appropriately selected from known materials used for forming a support depending on the purpose. Examples thereof include natural pulp derived form broad-leaved and needle-leaved trees, and a mixture of natural pulp and synthetic pulp.

The raw paper is preferably formed of broad-leaf bleached kraft pulp (LBKP) form the viewpoint of enhancing the surface smoothness, rigidity and dimensional stability (resistance to curling) to satisfactory levels. In addition to the broad-leaf bleached kraft pulp (LBKP), needle-leaf bleached kraft pulp (NBKP) or broad-leaf bleached sulfite pulp (LBSP) may be used for forming the raw paper.

The pulp may be beaten using a beater or a refiner.

The Canadian Standard Freeness (C.S.F.) of the pulp is preferably 200 mL C.S.F. to 440 mL C.S.F., and more preferably 250 mL C.S.F. to 380 mL C.S.F., since shrinkage of the paper can be controlled in papermaking.

Various additives are added, if necessary, to a pulp slurry formed after beating of the pulp (hereinafter the pulp slurry may be referred to as a “pulp paper material”). Examples of the additives include fillers, dry paper strengthening agents, sizing agents, wet paper strengthening agents, fixing agents, pH adjusters, pitch controlling agents, slime control agents and other agents.

Examples of the filler include calcium carbonate, clay, kaolin, white clay, talc, titanium oxide, diatomaceous earth, barium sulfate, aluminum hydroxide, magnesium hydroxide, calcined clay, calcined kaolin, delaminated kaolin, heavy calcium carbonate, light calcium carbonate, magnesium carbonate, barium carbonate, zinc oxide, silicon oxide, amorphous silica, aluminum hydroxide, calcium hydroxide, zinc hydroxide, urea-formalin resins, polystyrene resins, phenol resins and hollow microparticles.

Examples of the dry paper strengthening agent include cationic starch, cationic polyacrylamide, anionic polyacrylamide, amphoteric polyacrylamide and carboxy-modified polyvinyl alcohol.

Examples of the sizing agent include higher fatty acid salts; petroleum resins such as styrene-acrylic compounds; rosin, rosin derivatives (e.g., maleic rosin), paraffin waxes, alkyl ketene dimers, alkenyl succinic anhydrides (ASAs) and epoxidized fatty acid amides.

Examples of the wet paper strengthening agent include polyamine polyamide epichlorohydrin, melamine resins, urea resins, and epoxidized polyamide resins.

Examples of the fixing agent include polyvalent metal salts such as aluminum sulfate and aluminum chloride; basic aluminum compounds such as soda aluminate, basic aluminum chloride and basic polyaluminum hydroxide; polyvalent metal compounds such as ferrous sulfate and ferric sulfate; starch, processed starch, polyacrylamide, urea resins, melamine resins, epoxy resins, polyamide resins, polyamine resins, polyethylene imine, vegetable gum; water-soluble polymers such as polyethylene oxide; cationic polymers such as cationic starch; a dispersion of hydrophilic crosslinking polymer particles; and various compounds such as derivatives or modified products thereof.

Examples of the pH adjuster include caustic soda and sodium carbonate.

Examples of the other agents include defoaming agents, dyes and fluorescent whitening agents.

If necessary, a softening agent may be added to the pulp slurry. Examples of the softening agent include those described in, for example, Shin-Kamikakohinran “New edtion-Paper and Paper Treatment Manual (published by Shiyaku Time Co., Ltd., 1980) (pp. 554-555)”.

These additives may be used alone or in combination. The amount of the additive(s) to be added to the pulp paper material is not particularly limited and can be appropriately determined according to the purpose. Preferably, the amount is 0.1% by mass to 1.0% by mass.

As described above, the pulp slurry (pulp paper material) optionally contains various additives. The pulp paper material containing the additives is subjected to papermaking using a paper machine such as a manual paper machine, a Fourdrinier paper machine, a cylinder paper machine, a twin wire machine or a combination machine, followed by drying, to thereby produce raw paper. As desired, a surface sizing treatment may be carried out before or after drying.

A treatment liquid used for the surface sizing treatment is not particularly limited and can be appropriately selected according to the purpose. The liquid may contain a water-soluble polymer, a water-resistant substance, a pigment, a dye, a fluorescent whitening agent, etc.

Examples of the water-soluble polymer include cationic starch, oxidized starch, polyvinyl alcohol, carboxy-modified polyvinyl alcohol, carboxymethylcellulose, hydroxyethylcellulose, cellulose sulfate, gelatin, casein, sodium polyacrylate, sodium salts of styrene-maleic anhydride copolymers and sodium polystyrene sulfonate.

Examples of the water-resistant substance include latex/emulsions of styrene-butadiene copolymers, ethylene-vinyl acetate copolymers, polyethylene and vinylidene chloride copolymers; polyamide polyamine epichlorohydrin and synthetic waxes.

Examples of the pigment include calcium carbonate, clay, kaolin, talc, barium sulfate and titanium oxide.

The raw paper preferably has a ratio of vertical Young's modulus (Ea) to lateral Young's modulus (Eb) (i.e., Ea/Eb) within a range of 1.5 to 2.0, in terms of improving its rigidity and dimensional stability (resistance to curling).

As has been known, “stiffness” of paper generally varies depending on the beating method employed. The elastic force (elastic modulus) of paper obtained after beating and papermaking can be used as an important measure of the degree of stiffness. By using the relationship between density and dynamic elastic modulus of paper (which is indicative of physical properties of a viscoelastic substance), and the speed of sound traveling through the paper measured by an ultrasonic transducer, the elastic modulus of the paper can be determined by the following formula:

E=ρc²(1−n²)

wherein E denotes dynamic elastic modulus; ρ denotes density; c denotes the speed of sound traveling through paper; and n denotes a Poisson ratio.

In the case of generally used paper, since n in the above formula is as small as about 0.2, the dynamic elastic modulus can be determined without any significant difference by the following formula:

E=ρc²

In other words, the elastic modulus of paper can be easily determined using the density thereof and the speed of sound traveling therethrough. The speed of sound denoted by c in the above formula can be measured using a known tester such as Sonic Tester, Model SST-110 (product of Nomura Shoji Co., Ltd.,).

The thickness of the raw paper is not particularly limited and can be appropriately determined according to the purpose. The thickness is preferably 30 μm to 300 μm, more preferably 50 μm to 250 μm, still more preferably 100 μm to 250 μm.

The basis weight of the raw paper is not particularly limited and can be appropriately determined according to the purpose. The basis weight is preferably 30 g/m² to 300 g/m², more preferably 100 g/m² to 250 g/m².

The raw paper is preferably subjected to a calender treatment. The calender treatment is preferably carried out so that a metal roller comes into contact with a surface on which a coating layer is formed; i.e., a surface on the image-forming side (front surface).

The surface temperature of the metal rollers is preferably 100° C. or higher, more preferably 150° C. or higher, still more preferably 200° C. or higher. The upper limit of the metal roller surface temperature is not particularly limited and can be appropriately determined according to the purpose. For example, the upper limit temperature is preferably about 300° C.

The nip pressure of the rollers during the calender treatment is not particularly limited and can be appropriately determined according to the purpose. The nip pressure is preferably 100 kN/cm² or more, more preferably 100 kN/cm² to 600 kN/cm².

The type of a calender used in the calender treatment is not particularly limited and can be appropriately selected according to the purpose. Examples of the calender include a calender including a soft calender roller having a metal roller and a synthetic resin roller in combination; and a calender including a machinecalender roller having a pair of metal rollers.

### —Resin Layer—

The thickness of the resin layer formed at least on the image-forming side (front surface) of the raw paper is 5 μm to 15 μm, preferably 7 μm to 12 μm.

When the thickness is less than 5 μm, an even resin layer is difficult to form, potentially making noticeable irregularities on a white background. When the thickness is more than 15 μm, a transferred image may not exhibit satisfactorily high glossiness.

As described above, preferably, both surfaces of the raw paper are provided with the resin layer. In this case, the difference in thickness is preferably −3 μm to +3 μm, more preferably 0, between the front-surface resin layer on the image-forming side and the back-surface resin layer on the side opposite to the image-forming side.

When the difference is less than −3 μm or more than +3 μm in an electrophotographic image-receiving sheet, the sheet may exhibit poor rigidity or poor resistance to curling.

The thickness of the resin layer can be measured, for example, as follows: after separation of a resin layer from raw paper, the thickness of the resin layer is measured according to JIS K3170; or a cross-section of the resin layer is photographed by an electron microscope or a similar device for measurement of the resin layer thickness.

A resin forming the resin layer is preferably capable of forming a film, and is preferably polyolefin resins. Examples of preferred polyolefin resins include low-density polyethylene (LDPE), high-density polyethylene (HDPE), polypropylene, polymethylpentene and mixtures thereof. When the resin layer is formed from these resins on both surfaces of the raw paper, the resin composition of one layer may be different from that of the other layer in consideration of intended performance.

When the resin layer contains a mixture of low-density polyethylene (LDPE) and high-density polyethylene (HDPE), the ratio by mass (LDPE/HDPE) is preferably 10/90 to 90/10, more preferably 20/80 to 60/40.

As used herein, the term “low-density polyethylene” refers to polyethylene having a density of 0.930 g/cm³ or lower, preferably 0.925 g/cm³ or lower.

The term “high-density polyethylene” refers to polyethylene having a density of 0.945 g/cm³ or higher, preferably 0.950 g/cm³ or higher.

Preferably, the resin layer contains an organic or inorganic pigment in accordance with needs.

Examples of the organic pigment include ultramarine blue, cerian blue, phthalocyanine blue, cobalt violet, fast violet and manganese violet.

Examples of the inorganic pigment include titanium dioxide, calcium carbonate, talc, stearamide and zinc stearate. Of these, titanium dioxide is preferred.

The titanium dioxide may be of anatase type or rutile type. The titanium dioxide content of the resin layer is preferably 5% by mass to 30% by mass.

The method for forming the resin layer is not particularly limited and can be appropriately selected according to the purpose. Examples of the method include a normal lamination method; a sequential lamination method; a lamination method using a single-layer or multi-layer extrusion die, for example, of feet-block type, multi-manifold type or multi-slot type, a laminator and other devices; and a co-extrusion coating method in which a plurality of layers are formed at the same time by extrusion and coating. The shape of the single-layer or multi-layer extrusion die is not particularly limited and can be appropriately selected according to the purpose. For example, a T die or a coat-hanger die is preferably used.

The thickness of the support, which has the raw paper and the resin layer formed on at least one surface of the raw paper, is not particularly limited and can be appropriately determined according to the purpose. The thickness is preferably 35 μm to 330 μm, more preferably 55 μm to 280 μm, still more preferably 105 μm to 280 μm.

### <Coating Layer>

The coating layer contains at least hollow particles and, if necessary, a binder resin or other components.

The coating layer serves as a layer for receiving toner on a surface thereof, i.e., as a toner image-receiving layer. The coating layer is formed at least on the image-forming side of the support, and may be one or more in number. Both surfaces of the support may be provided with the coating layer for allowing application to double face printing.

### —Hollow Particles—

The hollow particles each contain a shell and air or other gases inside of the shell; i.e., are in a foamed state.

The shape of the hollow particle is not particularly limited, and the particle may be truly spherical, flat, amorphous, etc. Preferably, the hollow particle is spherical. Separately, preferably, the hollow particle is not deformed or broken during coating of a coating liquid for the coating layer on the support and drying subsequent to the coating. The volume average particle size of the hollow particles is preferably 0.3 μm or more, more preferably 0.3 μm to 3 μm, still more preferably 0.6 μm to 1.5 μm. By use of the hollow particles having a volume average particle size falling within the above ranges, an image formed of transferred toner exhibits high glossiness.

The volume average particle size is not particularly limited and measured by any known method. Examples of the method for measuring the particle size include a method by observation under an electron microscope; and a method by a laser diffraction particle size distribution analyzer or a similar device.

The hollow particles preferably have a void volume, which is defined by the following expression: (inner diameter of hollow particle/outer diameter of hollow particle)×100(%), of 20% to 95%, more preferably 30% to 70%, still more preferably 50% to 70%. The inner and outer diameters of the hollow particle can be measured using an electron microscope.

The material for forming the shell of the hollow particles is not particularly limited and can be appropriately selected according to the purpose. Examples of the material include styrene polymers, acrylic polymers, styrene-acrylic copolymers such as styrene-acrylonitrile copolymers and styrene-acrylonitrile-butadiene copolymers, polypropylene resins, polyvinyl chloride resins, polyvinylidene chloride resins, vinyl copolymers and urea-formalin resins. Of these, styrene-acrylic copolymers are particularly preferred.

Alternatively, crosslinked hollow particles are preferably used as the hollow particles forming the coating layer. The crosslinked hollow particles are those having a shell made of resin crosslinked by any method. Examples of the crosslinked hollow particles include those predominantly containing styrene-acrylic copolymers which have been crosslinked by divinylbenzene or other compounds during particle formation. In formation of the crosslinked hollow particles, the degree of crosslinking may be roughly determined as follows: an aliquot (100 mg) of dried hollow particles is added to a mixture (100 mL) of methyl ethyl ketone and toluene (mixing ratio by mass: 1:1); the resultant mixture is stirred at ambient temperature for eight hours; and the solid content of the mixture is measured. The solid content corresponds to the degree of crosslinking, and is preferably 60% by mass or more.

The type of the hollow particles is not particularly limited and commercially available products may be used. Examples include HP-1055, HP-91, HP-433J, AF-1353, OP-84J and Lowpaque ST (these products are of Rohm and Haas Company); MH-5055 (product of Zeon Corporation); SX866 (B), SX8782 (A) and SX8783 (P) (these products are of JSR Corporation); and SHP-100 (product of Samji Chemical).

The amount of the hollow particles (hollow particle content) contained in the coating layer is preferably 0.5 g/m² or more, more preferably 1.5 g/m² or more, still more preferably 5.0 g/m² to 11 g/m². When the amount is adjusted to 0.5 g/m² or more, formation of the trace of a roller during fixation can be prevented. In addition, the formed image exhibits satisfactorily high glossiness.

The amount of the hollow particles can be measured by any of the following methods: for example, a method by calculation from the difference in mass between a non-coated support and a coated support, and from the hollow particle content rate of a coating liquid; and a method in which after exfoliation of a coating layer, hollow particles of the layer are separated from a binder and other additives for measuring.

### —Binder Resin—

The type of the binder resin is not particularly limited and can be appropriately determined according to the purpose. Preferably, hydrophilic binders are used. Examples of the hydrophilic binder include gelatin, polyvinyl alcohol, polyethylene oxide, polyvinyl pyrrolidone, pullulan, carboxymethyl cellulose, hydroxyethyl cellulose, dextran, dextrin, polyacrylic acid and salts thereof, agar, κ-carageenan, λ-carageenan, τ-carageenan, casein, xanthen gum, locust bean gum, alginic acid, gum arabic, a polyalkyleneoxide copolymer and water-soluble polyvinyl butyral described in JP-A Nos. 07-195826 and 07-9757, and homopolymers and copolymers of vinyl monomers having a carboxyl group or a sulfonic acid group described in JP-A No. 62-245260. These compounds may be used alone or in combination. Among them, gelatin and polyvinyl alcohol are preferred.

The polyvinyl alcohol preferably has an average degree of polymerization of 300 or more, more preferably 1,000 to 5,000. The degree of saponification thereof is preferably 70 mol. % to 100 mol. %, more preferably 80 mol. % to 99.5 mol. %.

The gelatin is preferably an acid-treated gelatin or an alkali-treated gelatin.

The binder resin content of the coating layer is preferably 5 parts by mass to 50 parts by mass, more preferably 5 parts by mass to 20 parts by mass, still more preferably 5 parts by mass to 10 parts by mass, on the basis of 100 parts by mass of the hollow particles. When the binder resin content is adjusted to fall within the above ranges, the formed coating layer exhibits a sufficient strength. In addition, the formed electrophotographic image-receiving sheet can provide a high-glossiness printed image.

The coating layer may be formed by coating on the support a coating liquid for forming a coating layer (which liquid contains the binder resin, the hollow particles and water) and then by drying.

The method for coating the liquid is not particularly limited and can be appropriately selected according to the purpose. The coating of the liquid may be carried out by, for example, brush coating, a roller coater, a die coater or a curtain coater.

The thickness of the coating layer containing the hollow particles is preferably 2 μm or more, more preferably 5 μm or more, still more preferably 10 μm to 30 μm.

The electrophotographic image-receiving sheet of the present invention may include, together with the coating layer, at least one toner image-receiving layer containing at least a thermoplastic resin which layer is provided at a position farthest from the support.

Examples of the thermoplastic resin applicable to the toner image-receiving layer include those listed below.

(i) Polyolefin resins such as polyethylene resins and polypropylene reins; copolymer resins of olefins (e.g., ethylene and propylene) and other vinyl monomers, and acrylic resins.
(ii) Resins having an ester bond: for example, polyester resins formed by condensation between dicarboxylic acid compounds such as terephthalic acid, isophthalic acid, maleic acid, fumaric acid, phthalic acid, adipic acid, sebacic acid, azelaic acid, abietic acid, succinic acid, trimellitic acid and pyromellitic acid (wherein each dicarboxylic acid may have a sulfonic acid group or a carboxylic acid group as a substituent) and alcohol compounds such as ethylene glycol, diethylene glycol, propylene glycol, bisphenol A, a diethyl ether derivative of bisphenol A (e.g., an ethylene oxide diadduct of bisphenol A or a propylene oxide diadduct of bisphenol A), bisphenol S, 2-ethylcyclohexyldimethanol, neopentyl glycol, cyclohexyldimethanol and glycerin (wherein each alcohol may have a hydroxyl group or other groups as a substituent); polyacrylate or polymethacrylate resins such as polymethylmethacrylate, polybutylmethacrylate, polymethylacrylate and polybutylacrylate; polycarbonate resins; polyvinyl acetate resins; styrene acrylate resins; styrene-methacrylate copolymer resins; and vinyltoluene-acrylate resins; those described in, for example, JP-A Nos. 59-101395, 63-7971, 63-7972, 63-7973 and 60-294862; those commercially available such as Vylon 290, 200, 280, 300, 103, GK-140 and GK-130 (these products are of Toyobo Co.), Tuftone NE-382, Tuftone U-5, ATR-2009 and ATR-2010 (these products are of Kao Corporation), Elitel UE3500, UE3210 and XA-8153 (these products are of Unitika Ltd.) Polyster TP-220 and R-188 (these products are of Nippon Synthetic Chemical Industry Co.).
(iii) Polyurethane resins.
(iv) Polyamide resins and urea resins.
(v) Polysulfone resins.
(vi) Polyvinyl chloride resins, polyvinylidene chloride resins, vinyl chloride-vinyl acetate copolymer resins and vinyl chloride-vinyl propionate copolymer resins.
(vii) Polyol resins such as polyvinyl butyral; cellulose resins such as ethylcellulose resins and cellulose acetate resins.
(viii) Polycaprolactone resins, styrene-maleic anhydride resins, polyacrylonitrile resins, polyether resins, epoxy resins and phenol resins.

The above-listed thermoplastic resins may be used alone or in combination.

The toner image-receiving layer may have a single layer structure or a structure of two or more layers. The thickness of the toner image-receiving layer made of the thermoplastic resin(s) is preferably 0.1 μm to 50 μm, more preferably 0.5 μm to 10 μm.

The thermoplastic resin used for forming the toner image-receiving layer has preferably a glass transition temperature of 0° C. or higher, more preferably 20° C. or higher.

The thermoplastic resin is preferably water-dispersible. Examples of the water-dispersible resin include polyvinyl acetate, polyurethane, styrene-butadiene copolymers, acrylonitrile-butadiene polymers, polyacrylate esters, vinyl chloride-vinyl acetate copolymers, polybutylmethacrylate, ethylene-vinyl acetate copolymers, styrene-butadiene-acrylic copolymers and latex (e.g., polyvinylidene chloride).

### —Other Additives—

If necessary, the coating layer and the toner image-receiving layer may contain various additives other than the aforementioned hollow particles and binder resin(s) for the purpose of improving their thermodynamic characteristics.

Such additives may be appropriately selected according to the purpose, and examples include plasticizers, fillers, crosslinking agents, charge control agents, conductivity-imparting agents, pigments, surfactants, dyes, moisture control agents and matting agents.

The plasticizer controls fluidization or softening of the toner image-receiving layer caused by heat or pressure applied during fixation of toner thereon.

Examples of the plasticizer include those described in, for example, Kagaku Binran “Chemical Handbook” (edited by The Chemical Society of Japan, Maruzen), Kasozai-Sono riron to ouyou “Plasticizers—Theory and Application” (edited by Koichi Murai, Saiwai Shobo), Kasozai no kenkyu-jou “The Study of Plasticizers, Part 1” and Kasozai no kenkyu-ge “The Study of Plasticizers, Part 2” (edited by Polymer Chemistry Association) and Binran-Gomu purasuchikku haigou yakuhin “Handbook of Rubber and Plastics Blending Agents” (edited by Rubber Digest Co. Ltd.).

The filler which can be used is materials known as a reinforcing agent, a filler and a strengthening agent used for resin formation. Preferably, the filler is an organic or inorganic filler. It can be selected from those described in, for example, Binran-Gomu purasuchikku haigou yakuhin “Handbook of Rubber and Plastics Blending Agents” (edited by Rubber Digest Co., Ltd.), Shinhan-Purasuchikku haigouzai kiso to oyo “New Edition—Plastic Blending Agents: Basis and Application” (issued by Taiseisha) and “Filler Handbook” (issued by Taiseisha). Alternatively, various inorganic fillers (or pigments) may be used as the filler.

Examples of the crosslinking agent include compounds having in the molecule two or more known reactive groups selected from an epoxy group, an isocyanate group, an aldehyde group, an active halogen group, an active methylene group, an acetylene group and other groups; compounds having two or more groups which can form a hydrogen bond, an ionic bond, a coordination bond or other bonds; and compounds known as a coupling agent, a curing agent, a polymerizing agent, a polymerization promoter, a coagulating agent, a film-forming agent or a film-forming aid used for resin formation. Examples of the coupling agent include chlorosilanes, vinylsilanes, expoxysilanes, aminosilanes, alcoxyaluminium chelates, titanate coupling agents; and also include known coupling agents described in, for example, Binran-Gomu purasuchikku haigou yakuhin “Handbook of Rubber and Plastics Blending Agents” (edited by Rubber Digest Co. Ltd.).

The charge control agent can be used to, for example, control transfer or adhesion of toner and to prevent electrostatic adhesion of the electrophotographic image-receiving sheet. Examples of the charge control agent which can be used include antistatic agents and charge control agents such as surfactants (e.g., cationic surfactants, anionic surfactants, amphoteric surfactants and nonionic surfactants), polymer electrolytes and conductive metal oxides. In addition, examples of the charge control agent include, but are not limited to, cationic antistatic agents such as quaternary ammonium salts, polyamine derivatives, cationic modified polymethylmethacrylates and cationic modified polystyrenes; anionic antistatic agents such as alkylphosphates and anionic polymers; and nonionic antistatic agents such as fatty acid esters and polyethylene oxides. When toner particles are negatively charged, the cationic or nonionic antistatic agent is preferably used as the charge control agent.

Examples of the conductivity-imparting agent include metal oxides such as ZnO, TiO₂, SnO₂, A₂O₃, In₂O₃, SiO₂, MgO, BaO and MoO₃. These may be used alone or in combination. The metal oxide may further contain (i.e., doped with) an element other than constituent elements thereof. For example, ZnO may contain Al, In, etc., TiO₂ may contain Nb, Ta, etc., and SnO₂ may contain Sb, Nb, a halogen element, etc.

The pigment is used for improving image quality, in particular whiteness. Examples of the pigment include fluorescent whitening agents, white pigments, color pigments and dyes. Examples of the fluorescent whitening agent include known compounds having an absorption band within the near-ultraviolet region and emitting fluorescence light of 400 nm to 500 nm. Specific examples include compounds described in “The Chemistry of Synthetic Dyes, Volume V” (edited by K. Veen Rataraman, Chapter 8); e.g., stilbene compounds, coumarin compounds, biphenyl compounds, benzoxazoline compounds, naphthalimide compounds, pyrazoline compounds and carbostyril compounds. More specific examples include white furfar-PSN, PHR, HCS, PCS and B (these products are of Sumitomo Chemicals Co.) and UVITEX-OB (product of Ciba-Geigy Co.).

Examples of the dye which can be used include various known dyes such as oil-soluble dyes. Examples of the oil-soluble dye include anthraquinone compounds and azo compounds. Specific examples include vat dyes such as C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35; disperse dyes such as C. I. disperse violet 1, C. I. disperse violet 4, C. I. disperse violet 10, C. I. disperse blue 3, C. I. disperse blue 7 and C. I. disperse blue 58; C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55. In addition, a colored coupler used in silver halide photography may also be used.

As described above, the toner image-receiving layer may contain a matting agent. The matting agent is not particularly limited and can be appropriately selected according to the purpose. Examples of the matting agent include solid particles. The solid particles can be classified into inorganic particles and organic particles.

The whiteness of the electrophotographic image-receiving sheet of the present invention is not particularly limited and can be appropriately determined according to the purpose. The whiteness is preferably higher. Specifically, in the CIE 1976 (L*a*b*) color space, a value of L* is preferably 80 or more, more preferably 85 or more, particularly preferably 90 or more. The tint of white color is preferably as neutral as possible. Specifically, in the (L*a*b*) space, a value as calculated by (a*)²+(b*)² is preferably 50 or less, more preferably 18 or less, particularly preferably 5 or less.

The smoothness of the electrophotographic image-receiving sheet of the present invention is not particularly limited and can be appropriately determined according to the purpose. The smoothness is preferably higher. The arithmetic average roughness (Ra) (which is indicative of the smoothness) of a surface of the electrophotographic image-receiving sheet of the present invention is preferably 10 μm or less, more preferably 5 μm or less, still more preferably 1 μm or less, particularly preferably 0.5 μm or less.

The aforementioned arithmetic average roughness can be measured according to, for example, JIS B 0601, JIS B 0651 or JIS B 0652.

The glossiness of the electrophotographic image-receiving sheet of the present invention is preferably 50 or more, more preferably 65 or more, still more preferably 80 or more, particularly preferably 90 or more, over the whole range of white (i.e., no toner) to black (i.e., maximum toner density).

The surface electrical resistance of the electrophotographic image-receiving sheet of the present invention is preferably 1×10⁶Ω to 1×10¹⁵Ω (as measured at 25° C. and 65% RH). When the surface electrical resistance is less than 1×10⁶Ω, the toner image-receiving layer of the sheet cannot receive a sufficient amount of transferred toner, forming a toner image having low toner density. When the surface electrical resistance is more than 1×10¹⁵Ω, an amount of charge more than required is generated during toner transfer. Therefore, toner is not satisfactorily transferred, making the density of the formed image low. In addition, when the electrophotographic image-receiving sheet having such a surface electrical resistance is handled, the sheet generates static charge and thus tends to adsorb dusts. During copying, furthermore, misfeed, overfeed, discharge marks, toner dropouts, etc. are higher likely to occur, which is not preferred.

Examples of other layers forming the electrophotographic electrophotographic image-receiving sheet include a back layer, a surface-protective layer, a firm contact-improving layer, an intermediate layer, a cushion layer, an antistatic layer, a reflective layer, a tint-controlling layer, a shelf stability-improving layer, an anti-adhesion layer, an anti-curling layer and a smoothing layer. Each layer may be of a single layer structure, or may have a structure of two or more layers.

The electrophotographic image-receiving sheet of the present invention can provide a high-glossiness, high-quality image comparable to a silver-halide photograph with a single fixation (only a primary fixation). Therefore, the sheet is preferably used in various image forming methods, particularly preferably used in an image forming method of the present invention described below.

### (Image Forming Method)

An image forming method of the present invention includes a toner-image forming step and a fixing step and, if necessary, includes other steps.

### —Toner-Image Forming Step—

The toner-image forming step is a step of forming a toner image on an electrophotographic image-receiving sheet of the present invention.

The method employed in the toner-image forming step is not particularly limited, so long as a toner image can be formed on the electrophotographic image-receiving sheet, and can be appropriately selected according to the purpose. Examples of the method include a method used in usual electorophotography; e.g., a direct transfer method in which a toner image formed on a developing roller is transferred directly to an electrophotographic image-receiving sheet, or an intermediate transfer belt method in which a toner image formed on a developing roller is transferred primarily to an intermediate transfer belt or the like, and then a transferred toner image is transferred to an electrophotographic image-receiving sheet. Of these, the intermediate transfer belt method is preferably employed from the viewpoints of exhibiting environmental stability and attaining a high image quality.

### —Fixing Step—

The fixing step is a step of fixing a toner image formed in the toner-image forming step by a heating and pressing member.

Examples of the heating and pressing member include a pair of heating rollers and a combination of a heating roller and a pressing roller.

The pressing method is not particularly limited and can be appropriately selected according to the purpose. Preferably, a method by a nip pressure is employed. The nip pressure is preferably 1 kgf/cm² to 100 kgf/cm², more preferably 5 kgf/cm² to 30 kgf/cm², from the viewpoint of forming an image with excellent water resistance, surface smoothness and high glossiness. The heating temperature by the heating and pressing member is equal to or higher than the softening point of the polymer contained in the toner image-receiving layer. Generally, the heating temperature, which is varied depending on the polymer contained in the toner image-receiving layer, is preferably 80° C. to 200° C.

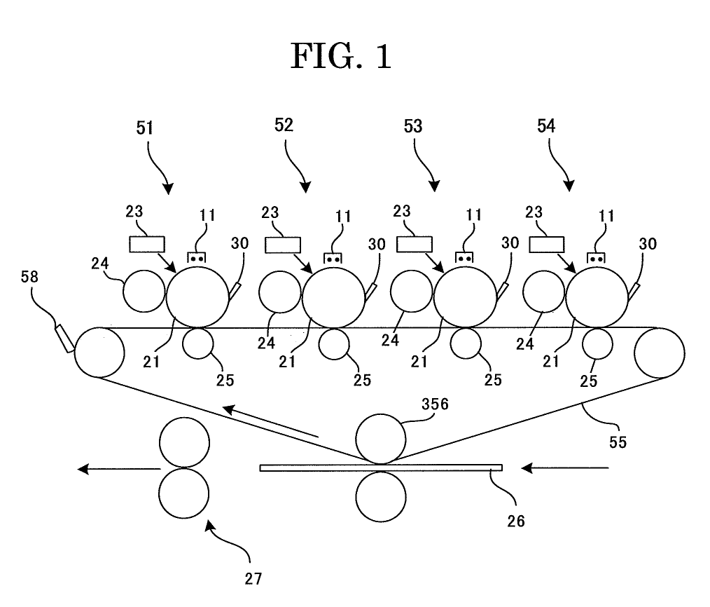

The image-forming apparatus shown in FIG. 1 is an indirect-transfer tandem image-forming apparatus employing a non-contact type charging method, a two-component developing method, a secondary transfer method, a blade cleaning method, and a roller fixing method by an internal heat source of a roller.

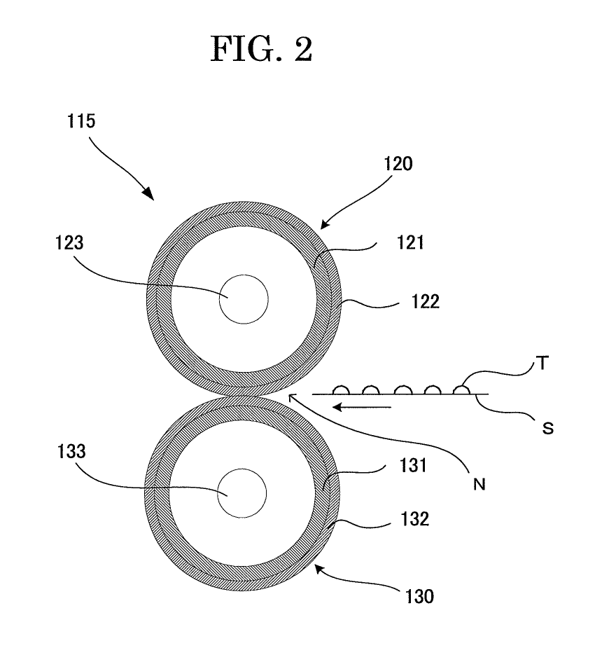

In the image-forming apparatus shown in FIG. 1, a non-contact type corona charger, a two-component developing device, a cleaning blade and a heating roller-fixing device (shown in FIG. 2) are employed as a charging unit 11, a developing unit 24, a cleaning unit 30 and a fixing unit 27, respectively.

An image-forming member 51 in the image-forming apparatus (shown in FIG. 1) includes a photoreceptor drum 21, a charging unit 11, a light-exposing unit 23, a developing unit 24, a primary transfer unit 25 and a cleaning unit 30, these units being arranged around the photoreceptor drum 21. While the photoreceptor drum 21 in the image-forming member 51 is rotated, an electrostatic latent image corresponding to a light-exposed image is formed on the drum surface by the charging unit 11 and the light-exposing unit 23. The electrostatic latent image is developed using yellow toner by the developing unit 24 to form a yellow-toner visible image on the photoreceptor drum 21. The visible image is transferred to an intermediate transfer belt 55 by the primary transfer unit 25. Residual yellow toner on the photoreceptor drum 21 is removed by the cleaning unit 30. Similarly, magenta-, cyan- and black-toner visible images are formed on the intermediate transfer belt 55 by image-forming members 52, 53 and 54, respectively. The thus-formed color image on the intermediate transfer belt 55 is transferred to a recording medium 26 by a transfer device 356. Residual toner on the intermediate transfer belt 55 is removed by an intermediate transfer belt-cleaning unit 58. The color image formed on the recording medium 26 is fixed by the fixing unit 27.

The heating roller-fixing device 115 shown in FIG. 2 includes a heating roller 120 serving as a fixing member, and a pressing roller 130 which contacts the heating roller. The heating roller 120 has a hollow metal-cylinder 121, an offset-preventing layer 122 formed on the cylinder, and a heating lump 123 provided therein. The pressing roller 130 has a metal cylinder 131 and an offset-preventing layer 132 formed on the cylinder. Notably, the pressing roller 130 may have a hollow metal-cylinder 131 and a heating lump 133 provided therein.

The heating roller 120 and the pressing roller 130 are pressed against each other by a spring (not illustrated). These rollers are rotatable in this pressed state, and a nip portion N is formed. The offset-preventing layer 122 of the heating roller 120 is lower in surface hardness than the offset-preventing layer 132 of the pressing roller 130. Therefore, in the nip portion N between the heating roller 120 and the pressing roller 130, a portion between the recording medium S-fed and discharged ends is closer to the axis of rotation of the heating roller 120 than are both the ends.

In the heating roller-fixing device 115 shown in FIG. 2, firstly, the recording medium S having a toner image T to be fixed is transferred to the nip portion N between the heating roller 120 and the pressing roller 130. Toner particles T on the recording medium S is crushed or fused by the heating roller 120, which has been heated to a predetermined temperature by the heating lump 123 provided in the roller. In parallel with this, as the recording medium S is passed through the nip portion N, the crushed/fused toner is pressed by the pressing roller 130, whereby the toner image T is fixed on the medium.

The recording medium S having the fixed toner image T is discharged from between the heating roller 120 and the pressing roller 130. In accordance with rotation of the heating roller 120, the recording medium S is peeled off from a heating roller surface, to which it has adhered, to be transferred to a tray (not illustrated). In this manner, the recording medium S is discharged toward the pressing roller 130 to prevent winding of the medium around the heating roller 120. The heating roller 120 is cleaned by a cleaning roller (not illustrated).

Since the image forming method of the present invention uses the electrophotographic image-receiving sheet of the present invention, the method can provide a high-glossiness, high-quality image comparable to a silver-halide photograph with a single fixation (only a primary fixation).

The present invention can solve existing problems, and can provide an electrophotographic image-receiving sheet which can provide a high-glossiness, high-quality image comparable to a silver-halide photograph with a single fixation (only a primary fixation) and which exhibits an excellent toner fixing property; and an image forming method using the electrophotographic image-receiving sheet.

### EXAMPLES

The present invention will next be described by way of examples, which should not be construed as limiting the present invention thereto.

### Example 1

### Preparation of Raw Paper

Wood pulp LBKP (broad-leaf bleached kraft pulp) was beaten by a double disk refiner so as to have a Canadian Standard Freeness (C.S.F.) of 300 mL. To the thus-beaten pulp material, 1.0 part by mass of cationic starch, 0.5 parts by mass of alkyl ketene dimer, 0.5 parts by mass of an epoxidized fatty acid amide, 0.3 parts by mass of polyamine polyamide epichlorohydrin, 0.03 parts by mass of a higher fatty acid ester and 0.02 parts by mass of colloidal silica were added on the basis of 100 parts by mass of the pulp material. The mixture was subjected to a papermaking treatment by a Fourdrinier paper machine so as to attain a basis weight of 160 g/m².

Thereafter, a calender treatment was carried out, to thereby prepare raw paper having a thickness of 160 μm.

The raw paper was impregnated with polyvinyl alcohol (PVA) at 1.0 g/m² and CaCl₂ at 0.8 g/m² by a size pressing device in the middle of a drying zone.

### —Formation of Resin Layer—

The front surface of the raw paper (i.e., the surface on the image-forming side) and the back surface thereof (i.e., the surface on the side opposite to the image-forming side) were subjected to a corona discharge treatment. Thereafter, the back surface of the raw paper was provided with a back surface-resin layer (thickness: 13 μm) by melt extrusion coating (at 320° C.) of a blend of low-density polyethylene (LDPE) and high-density polyethylene (HDPE) (blend ratio by mass: LDPE/HDPE=20/80). The front surface of the raw paper was provided with a front surface-resin layer (thickness: 13 μm) by melt extrusion coating (at 320° C.) of a blend of low-density polyethylene (LDPE) and high-density polyethylene (HDPE) (blend ratio by mass: LDPE/HDPE=20/80). Through the above procedure, a support of Example 1 was produced.

### —Formation of Coating Layer—

A coating layer-composition containing the components given below was coated on the resultant support by a wire coater, followed by drying at 90° C. for 1 minute, to thereby form a coating layer (weight in a dried state: 3.0 g/m²). The amount of hollow particles contained in the coating layer was found to be 2.7 g/m², and the amount of a binder contained in the coating layer was found to be 0.3 g/m².

### [Components of Coating-Layer Composition]

Water: 47 parts by mass

PVA (PVA117, product of KURARAY CO., LTD.): 3 parts by mass

Hollow particles (HP-1055, product of R&H Company, solid content: 26.5% by mass, void volume: 55%, volume average particle size: 1.0 μm): 50 parts by mass

### Examples 2 to 12 and Comparative Examples 1 to 9

The procedure of Example 1 was repeated, except that the blend ratios and the thicknesses of the front- and back-surface resin layers, and the amounts of the hollow particles and the binder contained in the coating layer were changed as shown in Tables 1-A and 1-B, to thereby produce electrophotographic image-receiving sheets of Examples 2 to 9, 11, 12 and Comparative Examples 1 to 9.

Separately, the procedure of Examples 2 to 9, 11, 12 and Comparative Examples 1 to 9 was repeated, except that PVA117 was changed to gelatin (alkali-treated gelatin), to thereby produce an electrophotographic image-receiving sheet of Example 10.

### Example 13

Using broad-leaf bleached kraft pulp (LBKP, prepared by the sulfate process) and needle-leaf bleached sulfite pulp (NBSP, prepared by the sulfate process), a white paper base (LBKP: 50% by mass, NBSP: 50% by mass) was formed so as to attain a basis weight of 160 g/m².

The surface of the white paper base, on which no image was formed, was provided with a back surface-resin layer (thickness: 10 μm) by melt extrusion lamination of polyethylene at 300° C.

The surface of the white paper base, on which an image was formed, was provided with a front surface-resin layer (thickness: 10 μm) by melt extrusion lamination (at 300° C.) of a kneaded product of LDPE (45% by mass), HDPE (46% by mass) and rutile-type titanium oxide (9% by mass). Through the above procedure, a support having resin layers on both surfaces thereof was formed.

A coating layer-composition containing the components given below was coated on the resultant support by a wire coater, followed by drying at 90° C. for 1 minute, to thereby form a coating layer (weight in a dried state: 6.0 g/m²). The amount of hollow particles contained in the coating layer was found to be 5.4 g/m², and the amount of a binder contained in the coating layer was found to be 0.6 g/m².

### [Components of Coating-Layer Composition]

Hollow particles (HP-1055, product of R&H Company, solid content: 26.5% by mass, void volume: 55%, volume average particle size: 1.0 μm): 68 parts by mass

Alkali-treated gelatin: 1.8 parts by mass

Aqueous 2,4-dichloro-6-hydroxy-1,3,5-s-triazine sodium salt solution (solid content: 7.5% by mass): 0.6 parts by mass

Aqueous dioctyl sodium sulfosuccinate solution (solid content: 20% by mass): 2 parts by mass

Water: 27.6 parts by mass

### Example 10

The procedure of Example 13 was repeated, except that the thickness of the back-surface resin layer, the thickness of the front-surface resin layer, the weight of the dried coating layer, the amount of the hollow particles contained in the coating layer and the amount of the binder contained in the coating layer were changed to 21 μm (20 g/m²), 16 μm (15 g/m²), 14.6 g/m² (thickness of coating layer: 40 μm), 13.0 g/m² and 1.3 g/m², respectively, to thereby produce an electrophotographic image-receiving sheet of Comparative Example 10.

Each of the thus-produced electrophotographic image-receiving sheets of Examples 1 to 13 and Comparative Examples 1 to 10 was evaluated for its various properties in the following manner. The results are shown in Tables 2-A and 2-B.

### <Appearance of Electrophotographic Image-Receiving Sheet>

The electrophotographic image-receiving sheets having a coating layer were evaluated for their appearances. Specifically, irregularities present on the sheet surface (white portion) were visually observed and the degrees were evaluated according to the following ratings:

A: Surface irregularities almost not noticeable

B: Surface irregularities somewhat noticeable

C: Surface irregularities noticeable

In these ratings, an electrophotographic image-receiving sheet rated as A or B is allowable in the present invention.

### <Resistance to Damage Formation by Roller>

An image was formed on the sheets using a color laser printer (DocuPrint C3250, (product of Fuji Xerox Co., Ltd.), this printer has a heating roller-fixing device shown in FIG. 2). Subsequently, the formed image was visually observed and evaluated according to the following ratings:

A: Damage by roller almost not noticeable

B: Damage by roller somewhat noticeable

C: Damage by roller noticeable

In these ratings, an electrophotographic image-receiving sheet rated as A or B is allowable in the present invention.

### <Resistance to Curling>

An image was formed on the sheets using a color laser printer (DocuPrint C3250, product of Fuji Xerox Co., Ltd.), followed by being left to stand at 20° C. and 50% RH. The sheets were evaluated for their curling statuses according to the following ratings:

A: No curling observed (i.e., excellent)

B: Not problematic curing observed

C: Problematic curing observed

In these ratings, an electrophotographic image-receiving sheet rated as A or B is allowable in the present invention.

### <Toner-Fixing Property>

An image was formed on the sheets using a color laser printer (DocuPrint C3250, product of Fuji Xerox Co., Ltd.). Thereafter, a piece of Sellotape (registered trademark) was applied to and peeled off from the black solid portion of the formed images. The thus-treated toner images were visually observed for their toner image-removal status, and the toner-fixing properties were evaluated according to the following ratings:

A: Toner image almost not removed

B: Toner image slightly removed

C: Less than ¼ of toner image removed

D: ¼ or more of toner image removed

In these ratings, an electrophotographic image-receiving sheet rated as A, B or C is allowable in the present invention.
<Glossiness (after Printing)>

Image formation was carried out by a color laser printer (DocuPrint C3250, product of Fuji Xerox Co., Ltd.), while increasing the color density in steps from white to black (i.e., maximum density), to thereby form a rectangular image (white, gray and black) on the sheets. Each image was analyzed for its glossiness at 75° by a digital variable-angle gloss meter (UGV-5D, product of SUGA TEST INSTRUMENTS CO., LTD.) according to JIS Z8741, and the determined glossiness was evaluated according to the following ratings:

A: Glossiness of 80% or more in whole range of density

B: Glossiness less than 80% in some range of density

C: Glossiness less than 65% in some range of density

D: Glossiness less than 50% in some range of density

In these ratings, an electrophotographic image-receiving sheet rated as A, B or C is allowable in the present invention.

TABLE 1-A

| | Front-surface resin | | Back-surface resin | | Hollow particles | Binder in |
|---|---|---|---|---|---|---|
| | | Thickness | | Thickness | in coating layer | coating layer |
| | Blend ratio | (μm) | Blend ratio | (μm) | (g/m²) | (g/m²) |
| Ex. 1 | LDPE:HDPE = 2:8 | 13 | LDPE:HDPE = 2:8 | 13 | 2.7 | 0.3 |
| Ex. 2 | LDPE:HDPE = 2:8 | 13 | LDPE:HDPE = 2:8 | 13 | 10.8 | 1.2 |
| Ex. 3 | LDPE:HDPE = 2:8 | 10 | LDPE:HDPE = 2:8 | 10 | 2.7 | 0.3 |
| Ex. 4 | LDPE:HDPE = 5:5 | 10 | LDPE:HDPE = 2:8 | 10 | 2.7 | 0.3 |
| Ex. 5 | LDPE:HDPE = 5:5 | 10 | LDPE:HDPE = 5:5 | 10 | 1.8 | 0.2 |
| Ex. 6 | LDPE:HDPE = 5:5 | 10 | LDPE:HDPE = 5:5 | 10 | 2.7 | 0.3 |
| Ex. 7 | LDPE:HDPE = 5:5 | 10 | LDPE:HDPE = 5:5 | 10 | 5.4 | 0.6 |
| Ex. 8 | LDPE:HDPE = 5:5 | 10 | LDPE:HDPE = 5:5 | 10 | 0.9 | 0.1 |
| Ex. 9 | LDPE:HDPE = 5:5 | 10 | LDPE:HDPE = 5:5 | 10 | 2.7 | 1.8 |
| Ex. 10 | LDPE:HDPE = 5:5 | 10 | LDPE:HDPE = 5:5 | 10 | 5.4 | 0.6 (gelatin) |
| Ex. 11 | LDPE:HDPE = 5:5 | 10 | LDPE:HDPE = 5:5 | 13 | 5.4 | 0.6 |
| Ex. 12 | LDPE:HDPE = 5:5 | 6 | LDPE:HDPE = 5:5 | 6 | 5.4 | 0.6 |
| Ex. 13 | LDPE:HDPE = 5:5 | 10 | LDPE:HDPE = 5:5 | 10 | 5.4 | 0.6 |

TABLE 1-B

| | Front-surface resin | | Back-surface resin | | Hollow particles | Binder in |
|---|---|---|---|---|---|---|
| | | Thickness | | Thickness | incoating layer | coating layer |
| | Blend ratio | (μm) | Blend ratio | (μm) | (g/m²) | (g/m²) |
| Comp. Ex. 1 | LDPE:HDPE = 2:8 | 10 | LDPE:HDPE = 2:8 | 10 | 0.0 | 0.6 |
| Comp. Ex. 2 | LDPE:HDPE = 5:5 | 10 | LDPE:HDPE = 5:5 | 10 | 0.0 | 0.6 |
| Comp. Ex. 3 | LDPE:HDPE = 5:5 | 10 | LDPE:HDPE = 5:5 | 10 | 0.4 | 0.1 |
| Comp. Ex. 4 | LDPE:HDPE = 5:5 | 25 | LDPE:HDPE = 5:5 | 25 | 5.4 | 0.6 |
| Comp. Ex. 5 | LDPE:HDPE = 5:5 | 25 | LDPE:HDPE = 5:5 | 25 | 10.8 | 1.2 |
| Comp. Ex. 6 | LDPE:HDPE = 5:5 | 25 | LDPE:HDPE = 5:5 | 25 | 16.2 | 1.8 |
| Comp. Ex. 7 | LDPE:HDPE = 5:5 | 4 | LDPE:HDPE = 5:5 | 4 | 5.4 | 0.6 |
| Comp. Ex. 8 | LDPE:HDPE = 5:5 | 4 | LDPE:HDPE = 5:5 | 4 | 10.8 | 1.2 |
| Comp. Ex. 9 | LDPE:HDPE = 5:5 | 16 | LDPE:HDPE = 5:5 | 21 | 5.4 | 0.6 |
| Comp. Ex. 10 | LDPE:HDPE = 5:5 | 16 | LDPE:HDPE = 5:5 | 21 | 13.0 | 1.3 |

TABLE 2-A

| | Appearance | Resistance | Resis- | Toner | |
|---|---|---|---|---|---|
| | (Before | to damage | tance to | fixing | Glossi- |
| | transfer) | by roller | curling | property | ness |
| Ex. 1 | A | A | A | B | C |
| Ex. 2 | B | A | A | C | B |
| Ex. 3 | B | A | A | B | C |
| Ex. 4 | A | A | A | B | B |
| Ex. 5 | A | B | A | A | C |
| Ex. 6 | A | A | A | B | B |
| Ex. 7 | A | A | A | B | A |
| Ex. 8 | A | B | A | B | C |
| Ex. 9 | A | A | A | B | C |
| Ex. 10 | A | A | A | B | A |
| Ex. 11 | A | A | B | B | A |
| Ex. 12 | B | A | A | B | A |
| Ex. 13 | A | A | A | C | B |

TABLE 2-B

| | Appearance | Resistance | Resis- | Toner | |
|---|---|---|---|---|---|
| | (Before | to damage | tance to | fixing | Glossi- |
| | transfer) | by roller | curling | property | ness |
| Comp. Ex. 1 | B | C | A | D | D |
| Comp. Ex. 2 | A | C | A | D | D |
| Comp. Ex. 3 | A | C | A | C | D |
| Comp. Ex. 4 | A | A | A | C | D |
| Comp. Ex. 5 | C | A | A | D | D |
| Comp. Ex. 6 | C | A | A | D | D |
| Comp. Ex. 7 | A | B | A | B | C |
| Comp. Ex. 8 | C | B | A | D | C |
| Comp. Ex. 9 | A | A | C | B | D |
| Comp. Ex. 10 | B | A | C | D | D |

### Example 14

The procedure of Example 7 was repeated, except that the hollow particle HP-1055 (product of R&H Company, solid content: 26.5% by mass, void volume: 55%, volume average particle size: 1.0 μm) was substituted, as shown in Table 3, with hollow particle HP-91 (product of R&H Company, solid content: 27.5% by mass, void volume: 50%, volume average particle size: 1.0 μm), to thereby produce an electrophotographic image-receiving sheet of Example 14.

The thus-produced electrophotographic image-receiving sheet of Example 14 was evaluated in a manner similar to that employed in Example 7. The results are shown in Table 4.

### Example 15

The procedure of Example 7 was repeated, except that the hollow particle HP-1055 was substituted, as shown in Table 3, with hollow particle HP-433J (product of R&H Company, solid content: 37.5% by mass, void volume: 33%, volume average particle size: 0.4 μm), to thereby produce an electrophotographic image-receiving sheet of Example 15.

The thus-produced electrophotographic image-receiving sheet of Example 15 was evaluated in a manner similar to that employed in Example 7. The results are shown in Table 4.

### Example 16

The procedure of Example 7 was repeated, except that the hollow particle HP-1055 was substituted, as shown in Table 3, with hollow particle AF-1353 (product of R&H Company, solid content: 26.5% by mass, void volume: 53%, volume average particle size: 1.3 μm), to thereby produce an electrophotographic image-receiving sheet of Example 16.

The thus-produced electrophotographic image-receiving sheet of Example 16 was evaluated in a manner similar to that employed in Example 7. The results are shown in Table 4.

### Example 17

The procedure of Example 7 was repeated, except that the hollow particle HP-1055 was substituted, as shown in Table 3, with hollow particle OP-84J (product of R&H Company, solid content: 42.5% by mass, void volume: 25%, volume average particle size: 0.55 μm), to thereby produce an electrophotographic image-receiving sheet of Example 17.

The thus-produced electrophotographic image-receiving sheet of Example 17 was evaluated in a manner similar to that employed in Example 7. The results are shown in Table 4.

### Example 18

The procedure of Example 7 was repeated, except that the hollow particle HP-1055 was substituted, as shown in Table 3, with hollow particle Lowpaque ST (product of R&H Company, solid content: 30.0% by mass, void volume: 44%, volume average particle size: 0.38 μm), to thereby produce an electrophotographic image-receiving sheet of Example 18.

The thus-produced electrophotographic image-receiving sheet of Example 18 was evaluated in a manner similar to that employed in Example 7. The results are shown in Table 4.

### Example 19

The procedure of Example 7 was repeated, except that the hollow particle HP-1055 was substituted, as shown in Table 3, with hollow particle MH-5055 (product of Zeon Corporation, solid content: 30% by mass, void volume: 55%, volume average particle size: 0.50 μm), to thereby produce an electrophotographic image-receiving sheet of Example 19.

The thus-produced electrophotographic image-receiving sheet of Example 19 was evaluated in a manner similar to that employed in Example 7. The results are shown in Table 4.

### Example 20

The procedure of Example 7 was repeated, except that the hollow particle HP-1055 was substituted, as shown in Table 3, with hollow particle SHP-100 (product of Samji Chemical, solid content: 26.5% by mass, void volume: 57%, volume average particle size: 1.0 μm), to thereby produce an electrophotographic image-receiving sheet of Example 20.

The thus-produced electrophotographic image-receiving sheet of Example 20 was evaluated in a manner similar to that employed in Example 7. The results are shown in Table 4.

TABLE 3

| | | | Hollow | |
|---|---|---|---|---|
| | Hollow particles | | particles in | Binder in |
| | Particle | Void | coating layer | coating layer |
| | size (μm) | volume (%) | (g/m²) | (g/m²) |
| Ex. 14 | 1.0 | 50 | 5.4 | 0.6 |
| Ex. 15 | 0.4 | 33 | 5.4 | 0.6 |
| Ex. 16 | 1.3 | 53 | 5.4 | 0.6 |
| Ex. 17 | 0.55 | 25 | 5.4 | 0.6 |
| Ex. 18 | 0.38 | 44 | 5.4 | 0.6 |
| Ex. 19 | 0.5 | 55 | 5.4 | 0.6 |
| Ex. 20 | 1.0 | 57 | 5.4 | 0.6 |

TABLE 4

| | Appearance | Resistance | Resis- | Toner | |
|---|---|---|---|---|---|
| | (Before | to damage | tance to | fixing | Glossi- |
| | transfer) | by roller | curling | property | ness |
| Ex. 14 | A | A | A | B | A |
| Ex. 15 | A | A | A | B | B |
| Ex. 16 | A | A | A | B | A |
| Ex. 17 | A | A | A | B | B |
| Ex. 18 | A | A | A | B | B |
| Ex. 19 | A | A | A | B | B |
| Ex. 20 | A | A | A | B | A |

An electrophotographic image-receiving sheet of the present invention can provide a high-glossiness, high-quality image comparable to a silver-halide photograph with a single fixation (only a primary fixation), and therefore, is preferably used in various image forming methods.

What is claimed is:

1. An electrophotographic image-receiving sheet comprising:
a support having raw paper and a resin layer on at least one surface of the raw paper, and
at least one coating layer on the support,
wherein the thickness of the resin layer at least on an image-forming side is 5 μm to 15 μm, the coating layer contains at least hollow particles, and the amount of the hollow particles contained in the coating layer is 0.5 g/m² or more.

2. The electrophotographic image-receiving sheet according to claim 1, wherein the volume average particle size of the hollow particles is 0.3 μm or more.

3. The electrophotographic image-receiving sheet according to claim 1, wherein the resin layer is formed on both surfaces of the raw paper, and the difference in thickness is −3 μm to +3 μm between the resin layer on the image-forming side and the resin layer on a side opposite to the image-forming side.

4. The electrophotographic image-receiving sheet according to claim 1, wherein the resin layer contains a mixture of low-density polyethylene (LDPE) and high-density polyethylene (HDPE), and the ratio LDPE/HDPE is 10/90 to 90/10 by mass.

5. An image forming method comprising:
forming a toner image on an electrophotographic image-receiving sheet, and
fixing the toner image by a heating and pressing member,
wherein the electrophotographic image-receiving sheet comprises a support having raw paper and a resin layer on at least one surface of the raw paper; and at least one coating layer on the support,
wherein the thickness of the resin layer at least on an image-forming side is 5 μm to 15 μm, the coating layer contains at least hollow particles, and the amount of the hollow particles contained in the coating layer is 0.5 g/m² or more.
